(19) United States
(12) Patent Application Publication
(10) Pub. No.: US 2015/0356691 A1
(43) Pub. Date: Dec. 10, 2015

(54) SYSTEM AND METHOD FOR RELATIVE RATING OF ARTISTIC WORKS

(71) Applicants: Ryan Barlow, Pflugerville, TX (US); James Barlow, Pflugerville, TX (US)

(72) Inventors: Ryan Barlow, Pflugerville, TX (US); James Barlow, Pflugerville, TX (US)

(21) Appl. No.: 14/298,912

(22) Filed: Jun. 7, 2014

(51) Int. Cl. G06Q 50/00; G06Q 30/02

(52) U.S. Cl. CPC G06Q 50/01; G06Q 30/02

(57) ABSTRACT

Certain embodiments are directed to systems and methods for providing a user specific relative rating system for categories of artistic works.

### BACKGROUND

Certain embodiments relate to providing a website for reviewing artistic works (“works”) and/or providing a social media forum for discussing the same.

Online content has dramatically increased in volume. Millions of people are now posting and/or commenting on posted content. Many of the people posting content online are posting to social networking website accounts. These postings can take the form of social posting, blogs, encyclopedic, and entertainment type postings. Many of these sites allow viewers to post comments related to a specific area of interest, e.g., hobbies and the like.

There remains a need for additional systems to allow users to manage and stay informed on subjects the user is interested in as well as providing a succinct presentation of opinions and ratings.

### SUMMARY

Certain embodiments are directed to a system or method for providing an individual a user based relative rating website. In certain aspects the users rate artistic works relative to other artistic works in the same genre or category. In a further aspect the user rates two or more works, e.g., films. The system or methods can provide an online network for those interested in one or more genre of artistic works and provide a system for the users to rate and share thoughts and opinions regarding artistic works. In certain aspects a website or similar electronic network for receiving user comment and input for various categories of artistic works is provided. Artistic works include films, books (a work of fiction or nonfiction in a written, printed, or electronic format), electronic games, videos, photography, poetry, performances, animations, music and so forth. Certain embodiments are related to rating, organizing, and managing opinions and commentary regarding films. Artistic works can be divided into genre based on stylistic criteria. For example, movies can be classified in the genre of science-fiction, drama, action, comedy, etc., based on the theme of the movie. In certain aspects a work can be included in more than one genre. As use herein, the term “category” is used for classifying types of works that include various forms of entertainment e.g. music, electronic games, literature, films, etc.

Certain aspects of the system and method described herein provides for the identification of an artistic work and the rating of that artistic work by the user. The user's rating is then stored. The rating is incorporated into the users rating history in the form of a relative rating to other artistic works previously rated by the user. This relative rating of a works can provide a third party viewing the user's rating a comparator to other works that the third party may have seen and has an opinion about as a reference point for a work rated by the user but not seen by the third party. The system and methods can further provide for communication between users to discuss and share opinions related to the various artistic works. In certain aspects the artistic work is a film. In a further aspect the discussion is an un-moderated or moderated discussion.

In certain aspects the system provides an interface for rating artistic works, i.e. a rating interface. The interface provides for receiving a rating input from a user that indicates how a first or presently experienced artistic work is rated. In certain aspects the server is programmed to select a certain subset of previously rated works for comparison and display purposes. In certain aspect a subset previously rated works can be selected for display by the user or the system. The subset of previously rated works can include 5, 10, 15, 20, 25, or more, including all values and ranges there between, of previously related works. The selected works for display of relative rating can be selected based on similarity to the currently rated work, all rated works, or a user defined set of works. The first or present rating is then compared to and/or presented in context of previously rated artistic works—for example the previously rated works can be superimposed on a rating scale for a work being rated. The rating criteria can be any standard rating scale. In certain aspect the rating is on a scale of 1 to 10, or 1 to 100. In certain aspects the first or present rating is incorporated into the user history or the user's rating profile. The updated user history or rating profile is then used for previously rated artistic works when a subsequent artistic work is rated. The rating interface can include fields for receiving inputs, buttons, or a sliding scale with an icon that a user can slide to indicate a rating. An artistic work can be rated in a number of characteristic, e.g., overall quality, special effects, cinematography, story line, acting, etc. Three classes of criteria can be used (i) required, (ii) optional, and (iii) custom. In certain aspects a default or recurrent set of criteria can be displayed. In other aspects the user is provided the opportunity to define its own criteria, that is generate custom criteria (user creates own). For example the system can be programmed to provide a set 5 criteria that may include (i) preconceived opinions, (ii) actual opinion, (iii) re-watchability, (iv) thought provoking, and (v) attention level. Other default categories may be provided.

In certain embodiments the system can produce an overall rating across all users for a particular artistic work. For example, an artistic work that has been reviewed by a number of users may have an average rating for all users associated with it, as well as a user specific rating. In certain aspects the average rating may be from a subset of users with a specialty in or fondness for the works being reviewed.

In certain aspects a registered or unregistered user can request controlled access to other users reviews or comments. In certain aspects a link can be provided to the reviewed work so that it can be purchased, streamed, and/or added to a play list. In other aspects the system will provide for the creation play lists for each genre or sub-genre (category) of artistic work.

The system is configured to provide the relative rating for each user's list of reviewed artistic works. The system is configured to sort items within a user's rating list and sort them relative to the user's rating of other works. In certain aspects the similarity of the works can be used to further sub-categorize the works. Thus, allowing a comparison within the context of the user's experience and tastes. In certain aspects the system provides for a graphical display of the artistic works reviewed and the user's rating. The graphical display can comprise an identifier of the works reviewed, e.g., a title or a small image identifying the artistic works, such as a thumbnail of the cover or jacket associated with the artistic work.

In certain aspects the users can rate other users and thus provide a metric of each users rating compared to other user's opinions. This aspect can be used to identify one or more users to follow or engage in discussion.

One advantage of the current system is that it eliminates fraudulent or artificially inflated ratings because each rating is user specific, lending credibility to certain users based on their ratings profile and discrediting those non-preferred ratings profiles.

As used in this disclosure the term “film,” “movie,” or “motion picture” refers to a series of still images which, when shown on a screen, creates the illusion of moving images. A film is created by photographing actual scenes with a motion picture camera; by photographing drawings or miniature models using traditional animation techniques; by means of CGI and computer animation; or by a combination of some or all of these techniques and other visual effects.

In the context of the present disclosure, the term “network” includes local area networks (LANs), wide area networks (WANs), the Internet, the World Wide Web, wireless telecommunications systems, fiber optic networks, and the like. Such networks are well known in the art and consequently are not further described here.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, repositories, file systems, record systems, object oriented databases, relational databases, SQL databases, audit trails and logs, program memory, cache and buffers, and the like.

In the context of the present invention, the term “network interface” describes the means by which users including website visitors access a network for the purposes of communicating across it or retrieving information from it.

In the context of the present invention, the term “user interface” describes any device or group of devices for presenting and/or receiving information and/or directions to and/or from persons. A user interface may comprise a means to present information to persons, such as a visual display projector or screen or the like. A user interface may also include a means to receive information or directions from persons, such as one or more or combinations of buttons, keys, levers, switches, knobs, touch pads, touch screens, microphones, speech detectors, motion detectors, cameras, and light detectors—real or virtual. Exemplary user interfaces comprise mobile phones, desktop computers, laptop computers, handheld and palm computers, keyboards, keypads, speech recognition devices, and the like.

The term “system” describes any computer information and/or control device, devices or network of devices, of hardware and/or software, comprising a processor, data storage, and user interface, which is adapted to communicate and provide the functions described herein via one or more data networks or connections.

The term “subscriber” or “user” refers to an entity that requests access to a particular website and its associated information. A subscriber or user may pay a fee in return for receiving all or part of the requested website information.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is a block diagram of a computer system configured to implement various systems and methods described herein according to some embodiments.

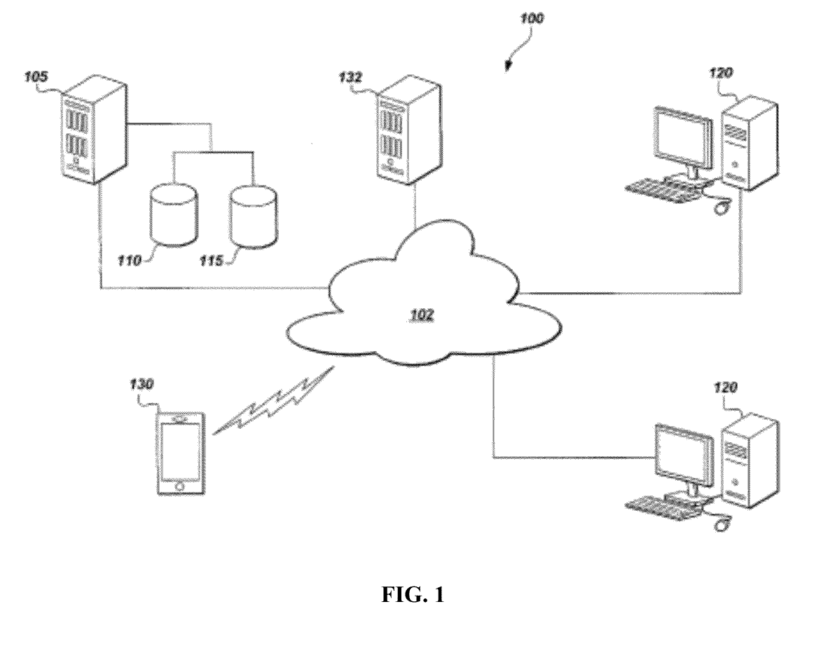

FIG. 2 is a flow chart describing a method of rating artistic works.

FIG. 3 is a graphical overview of selected functions of the system.

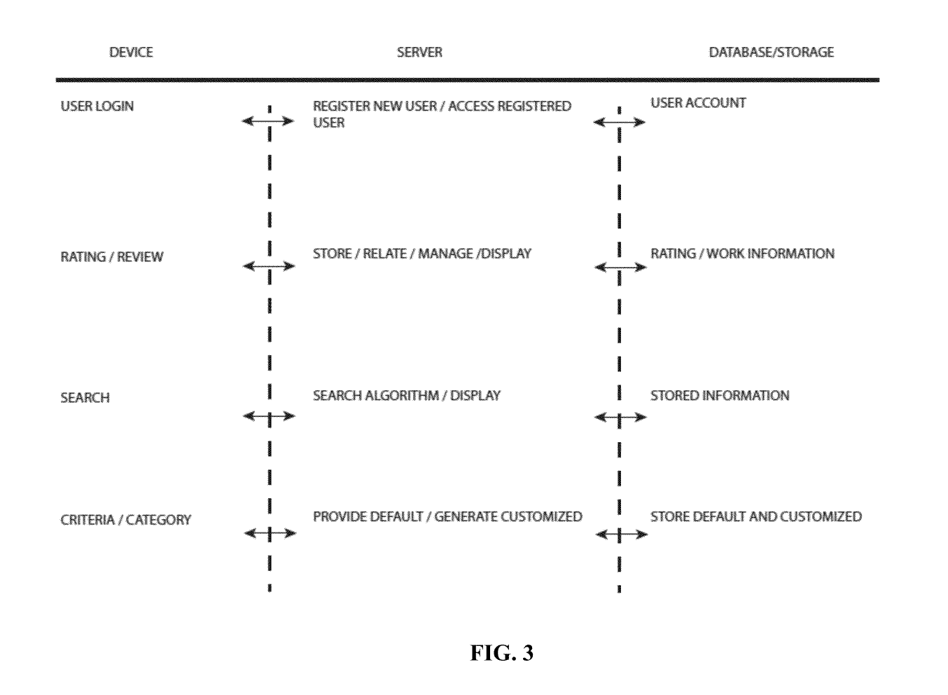

FIG. 4 is a screenshot of an example of a logon screen.

FIG. 5 is a screenshot of an example of a main page.

FIG. 6 is a screenshot of an example of an “add a film review page.”

FIG. 7 is a screenshot of an example of a dropdown menu accessible from the “add a film review page.”

FIG. 8 is a screenshot of an example of a film rating page.

FIG. 9 is a screenshot of an example of a relative film rating input page.

FIG. 10 is a second screenshot of an example of a relative film rating input page.

FIG. 11 is a screenshot of an example of an overview page.

FIG. 12 is a second screenshot of an example of an overview page.

FIG. 13 is a third screenshot of an example of an overview page.

### DESCRIPTION

Certain embodiments provide a system or method to allow a user interested in artistic works, such as films, to network online with other like-minded users who are also interested in such artistic works. Accordingly, certain aspects include an online social networking system for a user interested in rating and/or discussing artistic works to join as a user and communicate with other like-minded members through a networking environment provided by the system and methods described herein. In certain aspects user share their opinions and rating of various artistic works with other interested users.

In certain embodiments a server is configured to provide a graphical user interface. The interface can provide one or more of (i) a user registration and/or login, (ii) maintenance for user's account, (iii) adding or deleting ratings for an artistic work, and/or (iv) communication with other users of the system. In certain aspects a rating profile can be displayed as an interactive rating graphic having two or more artistic works presented in rating order. The rating graphic can be presented horizontally or vertically or in an ordered array in a low to high, or high to low arrangement. Each entry or rating on the rating graphic can be associated with a mouse over function that provides additional detail or selection for each work or rating.

In certain aspects the server is configured to (i) receive input from the user interface, (ii) sort and manipulate user rating relative to previously rated works, (iii) transmit information to storage, and (iv) display information for a user.

Data storage can be configured to (i) store user ratings, (ii) receive information from the server, and (iii) store information for each work.

Embodiments of a system for an artistic works relative rating system may be implemented or executed by one or more computer systems. The infrastructure 100 utilized by the system and methods described herein include Internet 102, and a plurality of servers and web-enabled user devices. A website may be hosted on a server 105 accessible via the Internet 102. User devices are web-enabled computers 120 or may also be a web enabled wireless mobile device, e.g., cellular telephone 130. Databases 110, 115 and servers 105 may be distributed in regional centers, localized, and/or be ubiquitously present within the Internet cloud 102. It should be understood that a website may be embodied in general purpose computer(s) having the appropriate peripherals attached thereto and software stored on a computer readable media that can be loaded into main memory and executed by a processing unit to carry out the functionality of the website and steps of the method(s) described herein.

The website may provide a downloadable application available to mobile device 130 to enable the mobile device 130 to access and interact with the system and methods described herein. A web page/user data store 110 and a artistic work comparison data store 115 are available to support databases having user/rating information, artistic work data, and user information. Users' web-enabled computers 120 access the system for providing information, ratings, and communications regarding artistic works, such as films.

In certain aspects the system restricts user database manipulation to that particular user profile

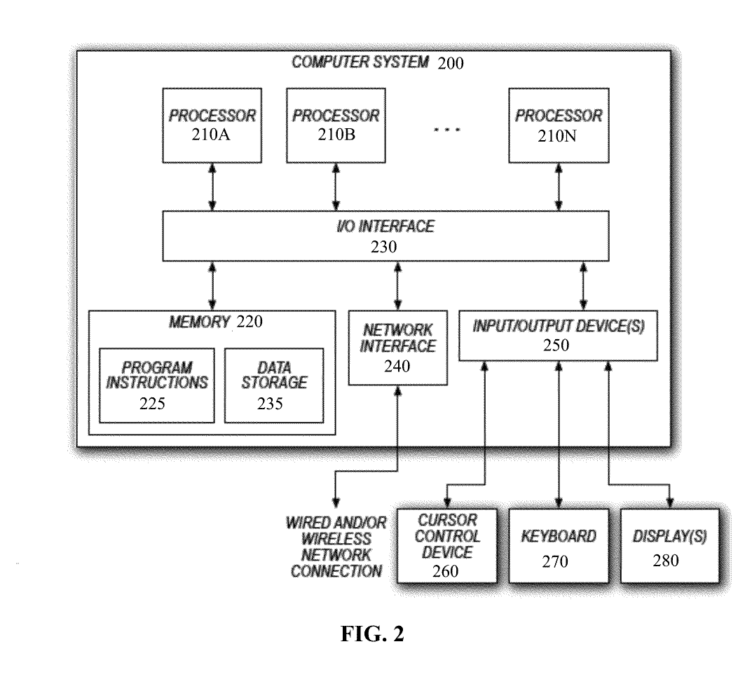

As illustrated in FIG. 2, a computer system can include one or more processors 210 coupled to a system memory 220 via an input/output (I/O) interface 230. The computer system can further includes a network interface 240 coupled to I/O interface 230, and one or more input/output devices 250, such as cursor control device 260, keyboard 270, and display(s) 280. In some embodiments, a given entity may be implemented using a single instance of a computer system, while in other embodiments multiple such systems, or multiple nodes making up the computer system, may be configured to host different portions or instances of embodiments. For example, in an embodiment some elements may be implemented via one or more nodes of computer system that are distinct from those nodes implementing other elements.

In various embodiments, the computer system may be a single-processor system including one processor 210, or a multi-processor system including two or more processors 210 (e.g., two, four, eight, or another suitable number). Processors 210 may be any processor capable of executing program instructions. For example, in various embodiments, processors 210 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 210 may commonly, but not necessarily, implement the same ISA. Also, in some embodiments, at least one processor 210 may be a graphics-processing unit (GPU) or other dedicated graphics-rendering device.

System memory 220 may be configured to store program instructions and/or data accessible by processor 210. In various embodiments, system memory 220 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described herein, may be stored within system memory 220 as program instructions 225 and data storage 235, respectively. In other embodiments, program instructions and/or data may be received, sent or stored upon different types of computer-accessible media or on similar media separate from system memory 220 or computer system 200. Generally speaking, a computer-accessible medium may include any tangible storage media or memory media such as magnetic or optical media—e.g., disk or CD/DVD-ROM coupled to computer system 200 via I/O interface 230. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 240.

In an embodiment, I/O interface 230 may be configured to coordinate I/O traffic between processor 210, system memory 220, and any peripheral devices in the device, including network interface 240 or other peripheral interfaces, such as input/output devices 250. In some embodiments, I/O interface 230 may perform any necessary protocol, timing or other data transformations to convert data signals from one component (e.g., system memory 220) into a format suitable for use by another component (e.g., processor 210). In some embodiments, I/O interface 230 may include support for devices attached through various types of peripheral buses, such as a variant of the Peripheral Component Interconnect (PCI) bus standard or the Universal Serial Bus (USB) standard, for example. In some embodiments, the function of I/O interface 230 may be split into two or more separate components, such as a north bridge and a south bridge, for example. In addition, in some embodiments some or all of the functionality of I/O interface 230, such as an interface to system memory 220, may be incorporated directly into processor 210.

Network interface 240 may be configured to allow data to be exchanged between computer system 200 and other devices attached to network 115, such as other computer systems, or between nodes of computer system 200. In various embodiments, network interface 240 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 250 may, in some embodiments, include one or more display terminals, keyboards, keypads, touch screens, scanning devices, voice or optical recognition devices, or any other devices suitable for entering or retrieving data by one or more computer system 200. Multiple input/output devices 250 may be present in computer system 200 or may be distributed on various nodes of computer system 200. In some embodiments, similar input/output devices may be separate from computer system 200 and may interact with one or more nodes of computer system 200 through a wired or wireless connection, such as over network interface 240.

As shown in FIG. 2, memory 220 may include program instructions 225, configured to implement certain embodiments described herein, and data storage 235, comprising various data accessible by program instructions 225. In an embodiment, program instructions 225 may include software elements of embodiments illustrated in FIG. 2. For example, program instructions 225 may be implemented in various embodiments using any desired programming language, scripting language, or combination of programming languages and/or scripting languages (e.g., C, C++, C#, JAVA®, JAVASCRIPT®, PERL®, etc). Data storage 235 may include data that may be used in these embodiments. In other embodiments, other or different software elements and data may be included.

A person of ordinary skill in the art will appreciate a computer system described herein is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

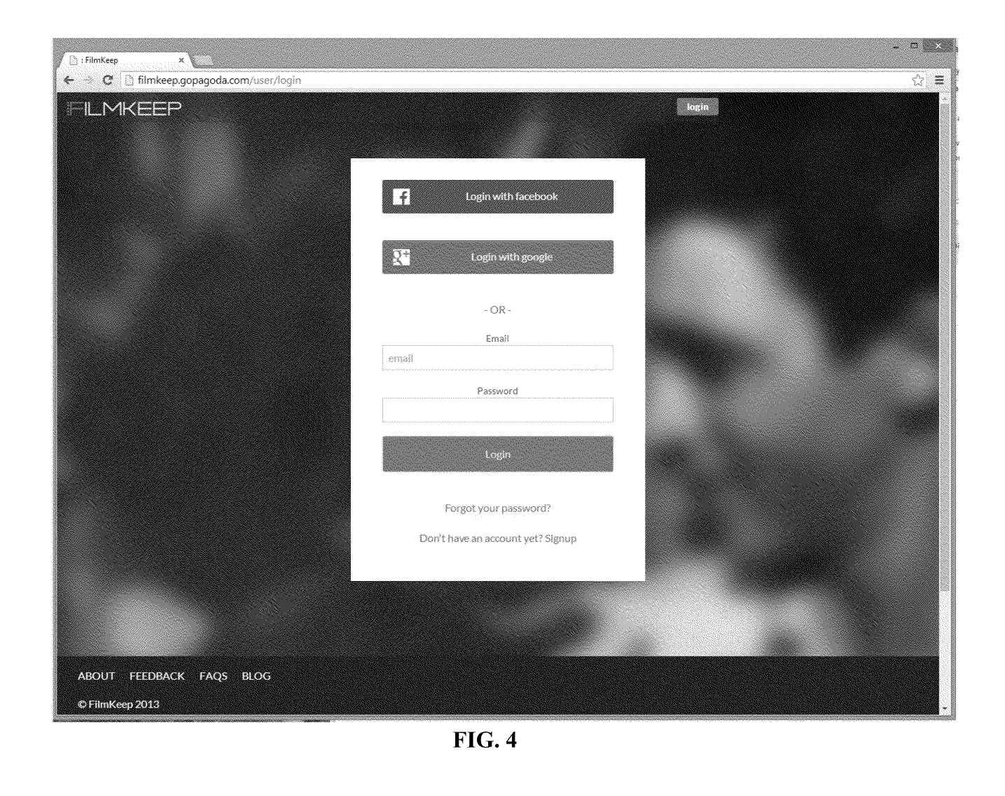

The server provides for generation of GUI from which a user can access and communicate with the server. One such embodiment includes the FILMKEEP pages and system that are used as an example of the system described herein. FIG. 4 shows an example of a display that is provided when a user make first contact with the server. The logon page can provide various options for logon, e.g., logon with FACEBOOK™, logon with GOOGLE™, or logon using email/password combination. A password or user name recovery inquiry may also be provided to request recovery or reminder information be processed by the server. An interface may also be provided that activates a new account process to establish a user account on the server and respective database(s).

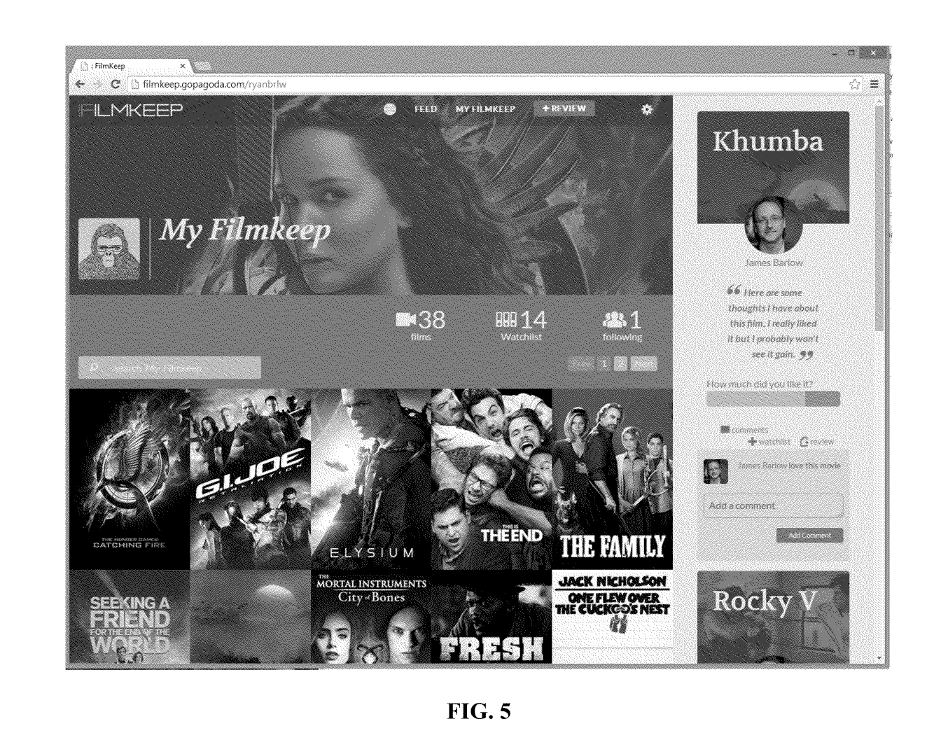

After successful login the server will provide a main menu screen, for example see FIG. 5. The main menu interface can provide a menu bar having options including, but not limited to accessing users settings or adding new review/rating entry. The main menu interface can also provide a search function for searching the database(s) accessible by the server. The main menu page, as well as other pages, can have a subscreen for input and viewing of commentary from one or more users regarding any number of topics, include opinions on various works of art.

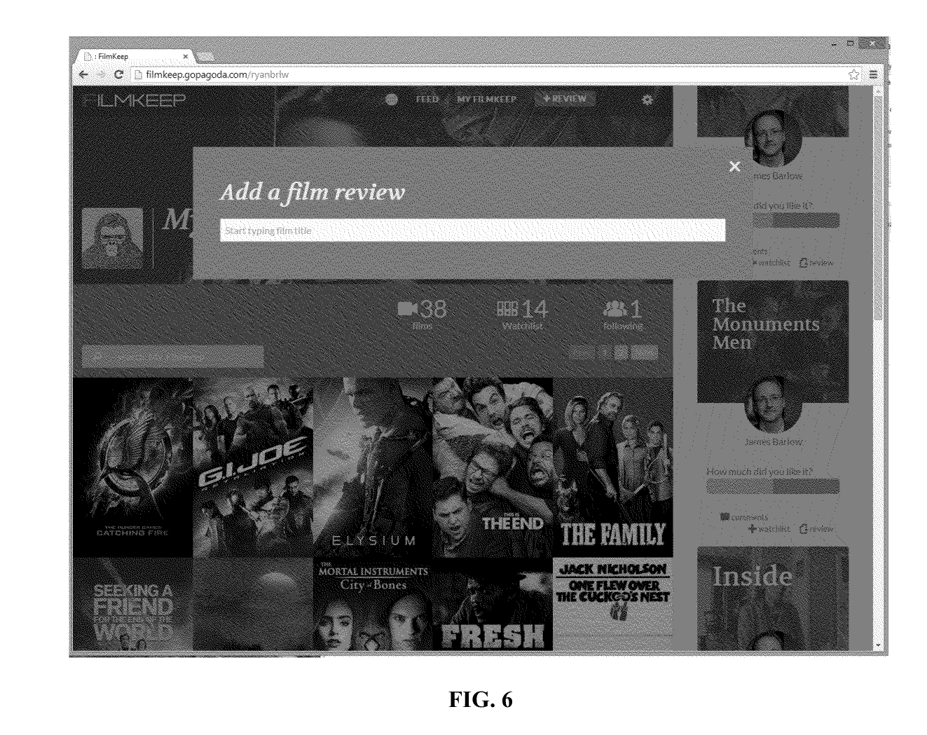

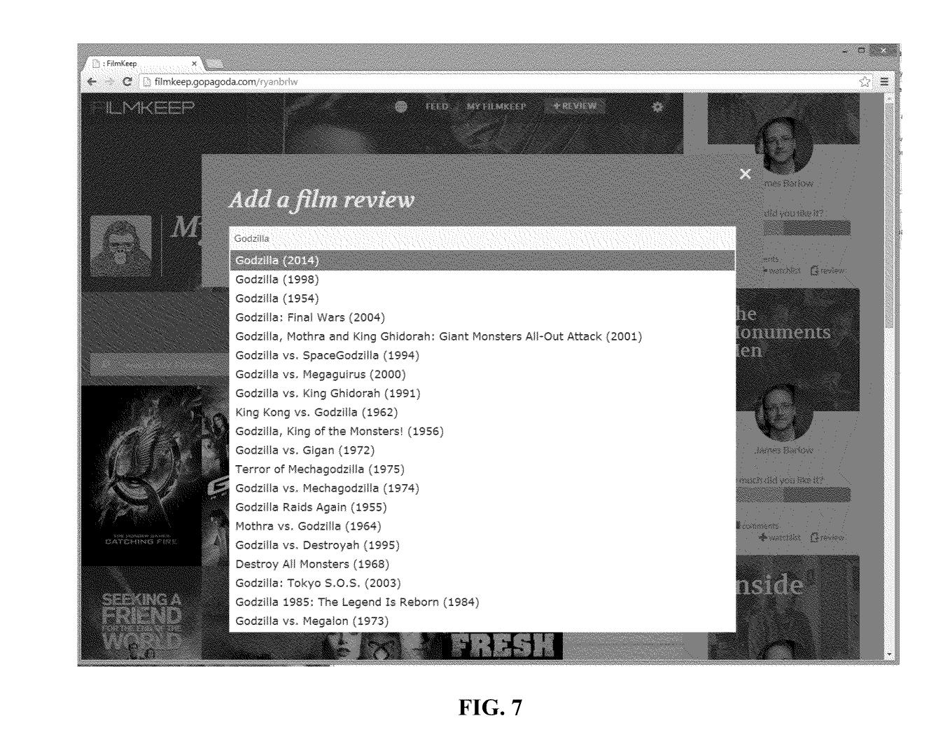

From the main menu a user can elect to add a new or revise an existing review or rating. By either selecting an add a new review option or searching for an existing review or rating the server will provide a rating interface, for example see FIG. 6. The rating review interface can provide for entry of text to identify a work of art to be rated. In certain aspects the entry can be coupled to an autofill and/or dropdown menu (see FIG. 7) function to assist the user in completing the entry. A search field can be provided to initiate search once the user has entered search criteria.

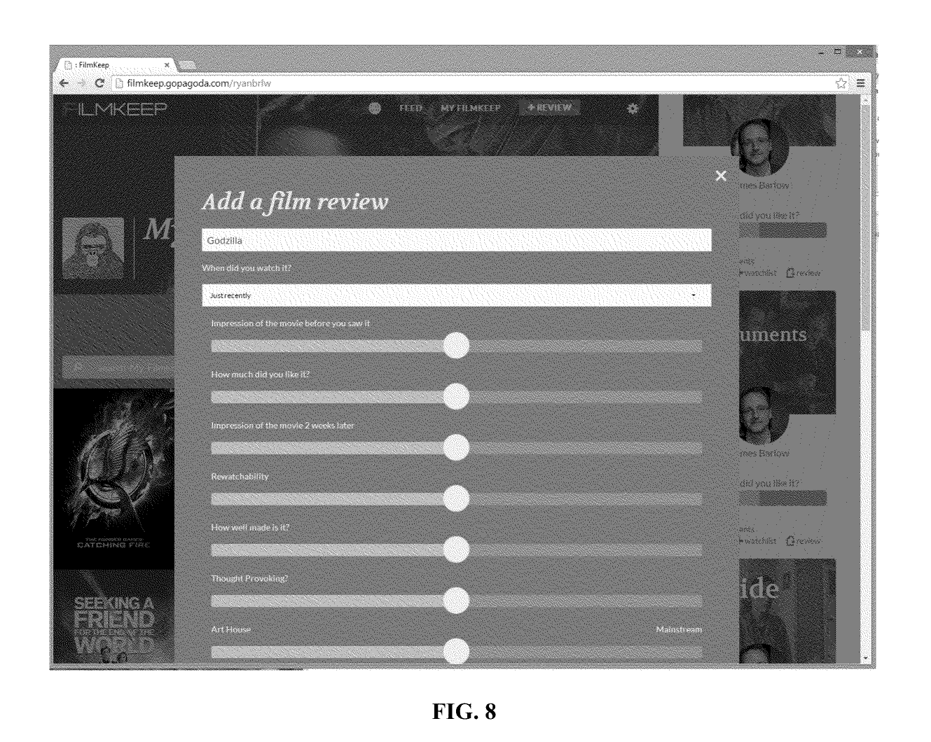

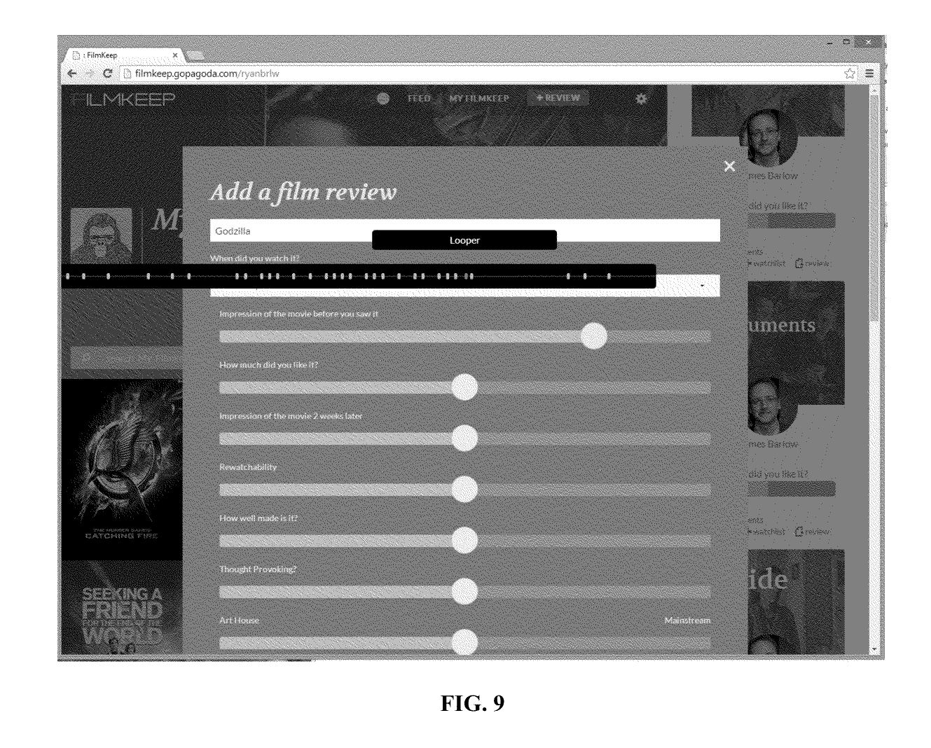

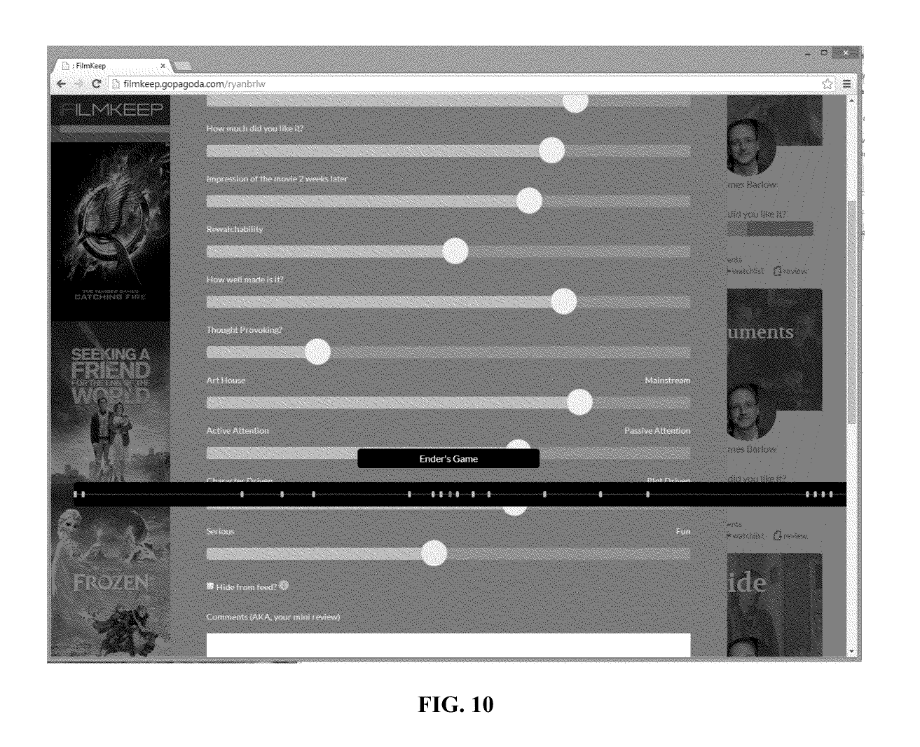

Once a work is identified through the use of the work identification field the server will provide for a rating interface, for example see FIG. 8, FIG. 9, and FIG. 10. The rating interface can provide the user with the title of the work being rated, a comment entry field, and/or a plurality of rating interfaces that are individually associated with a rating category or characteristic to be rated. The rating interface can be displayed a slide tool having a point that can be repositioned along the slide to indicate a value for the particular category or characteristic being rated. As shown in FIG. 9 and FIG. 10 the server or displaying device will provide for a hover feature, that is once a pointer or cursor maintains a position over a certain location on the interface a secondary display is overlaid on the primary display. In certain aspect hovering over a category or characteristic will provide a secondary display that includes ratings from other previously rated works. In certain aspects the ratings will be from a similar or the same genre. In certain aspects the previously rated works may be a certain numbers of works from that genre. The number of works displayed in the secondary display can be the last 10 or 20 works rated, the last 10 or 20 works rated for that particular genre, the last 10 or 20 works associated with a user defined criteria, etc. In certain aspects there will be an point or icon representing each previously rated work that is linked to information on that work that can be displayed by hovering over that point on the secondary display. Hovering activates a request that is received by the server, which responds by transmitting the information to the device, and may retrieve such information from an associated database(s).

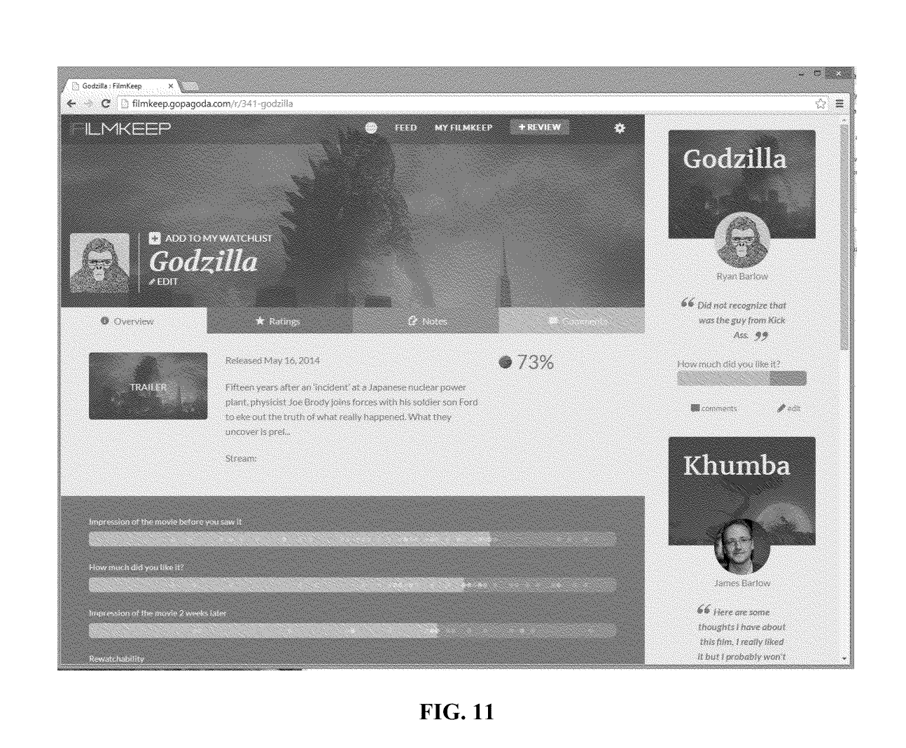

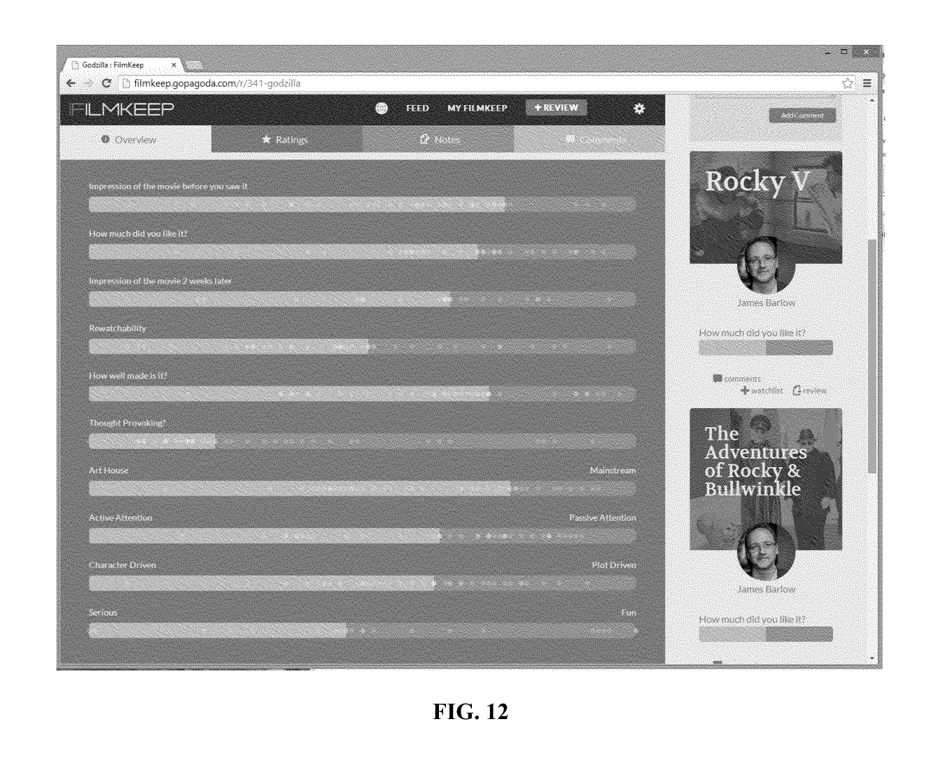

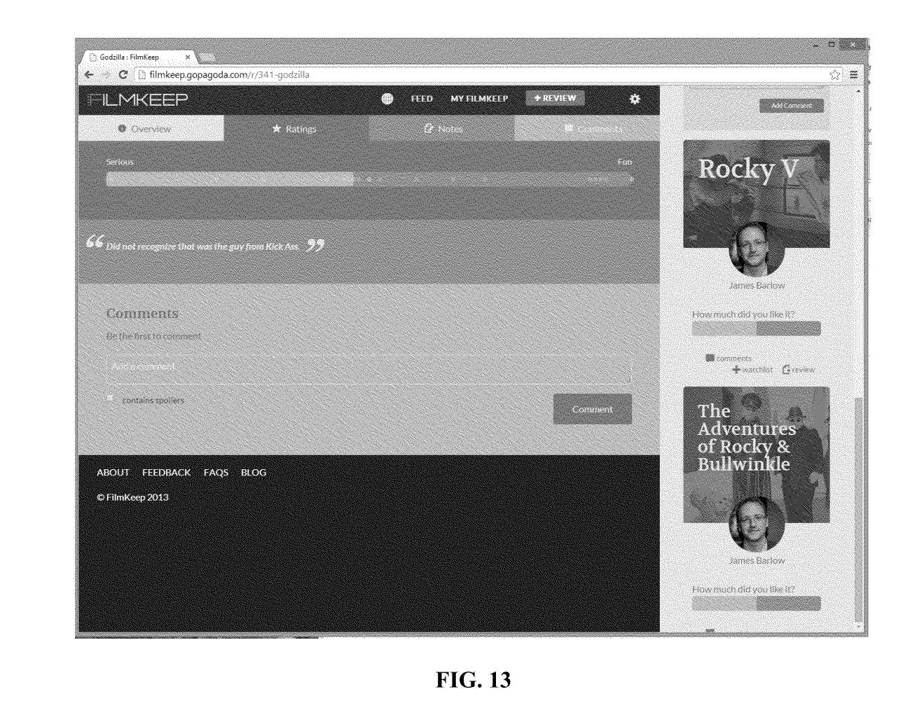

A user may access an overview page for a particular work by using a search function provided. An overview page, such as the example provided in FIG. 11, FIG. 12, and FIG. 13, can provide a summary of the rating of a particular work relative to other previously rated works across a number of categories or characteristics. The rating can be provided in a linear sliding scale with differential shading or other visual indication as to the current rating to the work that is the subject of the overview with points representing previously rated works superimposed on the scale. The superimposition of previously rated values can be used to relate the currently rated or viewed work to other works rated by the same user. In certain embodiments a separate indicator may be superimposed that show a cumulative or average rating for a work from all or a selected subset of system users.

1. A method for user rating of artistic works, comprising:
receiving registration information from a user;
generating or providing access to a user account;
receiving a rating for a first selected artistic work from the user;
storing the rating;
sorting the rating for the first artistic work relative the ratings of artistic works previously rated by the user and generating a relative rating for the artistic work; and
transmitting the relative rating of the first artistic work relative to previously rated artistic works for display.

2. The method of claim 1, wherein the artistic work is a film.

3. The method of claim 1, further comprising providing for the display of the user's relative rating of a selected film to a third party in a non-editable format.

4. A system, comprising:
at least one processor configured to receive rating information from a user and to generate a relative rating for an artistic work; and
a memory coupled to the at least one processor, the memory configured to store program instructions executable by the at least one processor to cause the system to:
receive a rating for a first artistic work from a subject,
sort the rating for the first artistic work relative to ratings of previously rated artistic works and generating a relative rating of artistic works, and
transmit the relative rating of the first artistic work relative to previously rated artistic works for display.

5. The system of claim 4, wherein the artistic work is a film.
